(19) United States
(12) Patent Application Publication
(10) Pub. No.: US 2006/0037034 A1
(43) Pub. Date: Feb. 16, 2006

(54) Apparatus for preventing duplicate insertion of discs to an optical disc drive

(75) Inventor: Hwan-seung Lee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/190,908

(22) Filed: Jul. 28, 2005

(30) Foreign Application Priority Data
Aug. 11, 2004 (KR) 2004-63218

(51) Int. Cl. G11B 17/04; G11B 33/02

(52) U.S. Cl. 720/623; 720/647

(57) ABSTRACT

An duplicate insertion prevention apparatus for a disc drive, includes at least one door lever to guide a disc being inserted to a disc drive, in contact with the disc, and a duplicate insertion prevention lever to restrain the door lever from rotating when a disc is in operation in the disc drive, preventing insertion of another disc. Accordingly, a simple-structured and compact-sized disc drive may be implemented.

### CROSS-REFERENCE TO RELATED APPLICATIONS

This application claims the benefit of Korean Patent Application No. 2004-63218, filed Aug. 11, 2004, in the Korean Intellectual Property Office, the disclosure of which is incorporated herein by reference.

### BACKGROUND OF THE INVENTION

1. Field of the Invention

The present invention relates to a disc drive. More particularly, the present invention relates to a duplicate insertion prevention apparatus to prevent insertion of a disc when another disc is already in operation in a disc drive.

2. Description of the Related Art

Generally, disc drives record and reproduce information with respect to discs such as a compact disc (CD), a compact disc read-only-memory (CD-ROM), digital video disc (DVD) and a DVD-ROM.

Recently, a slot-in type disc drive without a tray has been widely used to reduce a size thereof and save space. Also, a loading apparatus which is able to selectively load discs in different sizes, for example, 80 mm and 120 mm, has been widely used.

However, because the slot-in type disc drive does not include a tray, a user may accidentally insert a disc to the disc drive although another disc is already in operation in the disc drive, causing damage to the disc and other major parts of the disc drive. As a result, an apparatus to prevent duplicate insertion of discs becomes essential. Further a duplicate insertion prevention apparatus having a simple structure and a few number of parts is required for a compact size of the apparatus and low manufacturing cost.

### SUMMARY OF THE INVENTION

An aspect of the present invention is to solve at least the above problems and/or disadvantages and to provide at least the advantages described below. Accordingly, an aspect of the present invention is to provide a duplicate insertion prevention apparatus for a disc drive, which is simply structured with a few number of component parts.

Additional aspects and/or advantages of the invention will be set forth in part in the description which follows and, in part, will be apparent from the description, or may be learned by practice of the invention.

The foregoing and/or other aspects of the present invention are also achieved by providing a duplicate insertion prevention apparatus including at least one door lever to guide a disc being inserted to a disc drive, in contact with the disc, and a duplicate insertion prevention lever to restrain the door lever from rotating when a disc is in operation in the disc drive, preventing insertion of another disc.

According to an aspect of the invention, the door lever includes a first door lever and a second door lever.

According to an aspect of the invention, the first and the second door levers respectively include first and second door projections contacted with the disc to guide the disc.

According to an aspect of the invention, the duplicate insertion prevention lever moves among an initial position where the disc is being inserted, an intermediate position where the disc is placed in a chucking position, and a final position where the disc is rotating on a turn table.

According to an aspect of the invention, the intermediate position and the final position are determined to be different according to a size of the disc being inserted.

According to an aspect of the invention, the duplicate insertion prevention lever includes an insertion prevention projection to obstruct the second door lever, restraining rotation of the second door lever when another disc is additionally inserted.

According to an aspect of the invention, the second door lever includes a stopper and a guide groove still being selectively contacted with the insertion prevention projection according to a size of the disc.

According to an aspect of the invention, the first door lever includes a protruded cam being contacted with a start switch that operates a driving motor, and a cam slot to guide a movement of the second door lever.

According to an aspect of the invention, the duplicate insertion prevention apparatus may further include an elastic member to connect the first and the second door levers.

### BRIEF DESCRIPTION OF THE DRAWINGS

The above and/or other aspects and advantages of the invention will become apparent and more readily appreciated from the following description of the embodiments, taken in conjunction with the accompanying drawings of which:

FIG. 1 is a plan view of a disc loading apparatus adopting a duplicate insertion prevention apparatus, according to an embodiment of the present invention;

FIGS. 2 and 3 are views explaining an operation of the duplicate insertion prevention apparatus when a 80 mm disc is inserted in the disc loading apparatus of FIG. 1;

FIGS. 4 and 5 are views explaining an operation of the duplicate insertion prevention apparatus when a 120 mm disc is inserted in the disc loading apparatus of FIG. 1;

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

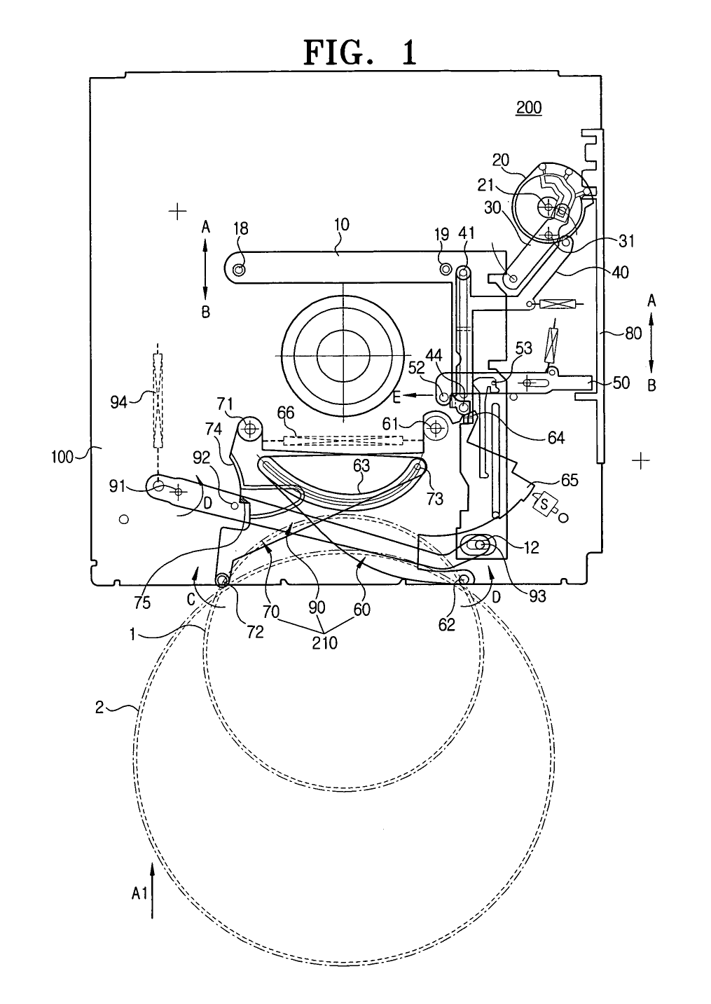

A first disc 1 is a general 80 mm disc, and a second disc 2 is a 120 mm disc. A disc loading apparatus according to an embodiment of the present invention is applied to a slot-in type disc drive which is able to compatibly load discs in different sizes without a disc tray. FIG. 1 illustrates a disc loading apparatus 200 for a disc drive having a duplicate insertion prevention apparatus, according to an embodiment of the present invention. As shown in FIG. 1, a duplicate insertion prevention apparatus 210 according to an embodiment of the present invention comprises a first door lever 60, a second door lever 70 and a duplicate insertion prevention lever 90. The duplicate insertion prevention apparatus 210 is disposed on a front of a main chassis 100 of the disc loading apparatus 200 to guide insertion of the discs 1 and 2 and also prevents insertion of one of the discs 1 and 2 when the other one of the discs 1 and 2 is already inserted.

The first door lever 60 is mounted on the main chassis 100 to rotate with respect to a first door lever rotary shaft 61. The first door lever 60 includes a first door projection 62, a protruded cam 65, a pushing projection 64, and a cam slot 63.

The first door projection 62 is provided on the first door lever 60 to guide insertion of the discs 1 and 2 in contact with the discs 1 and 2. When the first door lever 60 is rotated by insertion of a disc, the protruded cam 65 is brought into contact with a starting switch S, operating a driving motor (not shown). Accordingly, a transfer roller (not shown) rotates and draws the discs 1 and 2 into the disc drive.

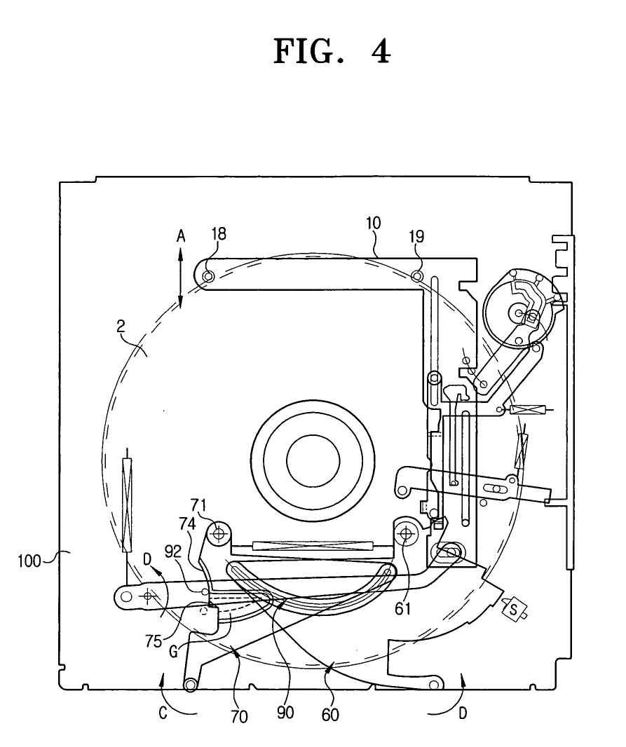

When the second disc 2 is inserted, the pushing projection 64 pushes out a locking lever 40 such that a disc guide lever 10 is more lifted up in ‘A’ direction compared to when the first disc 1 is inserted. More specifically, when inserting the second disc 2 having a greater diameter than the first disc 1, the first door lever 60 is rotated in ‘D’ direction with respect to the first door lever rotary shaft 61 by a greater degree compared to when inserting the first disc 1. Accordingly, the pushing projection 64 pushes a position controlling projection 44 of the locking lever 40, which is disposed adjacent thereto. Therefore, a stopper projection 52 of a pushing lever 50 that is associated with the position controlling projection 44 is biased in ‘E’ direction by a predetermined distance, thereby enabling the disc guide lever 10 to be lifted in the ‘A’ direction without interference by the position controlling projection 44 of the locking lever 40, as shown in FIG. 4.

The cam slot 63 receives a cam projection 73 of the second door lever 70 and guides a movement of the cam projection 73 when the first and the second door levers 60 and 70 rotate.

An elastic member 66 interconnects the first and the second door levers 60 and 70, so that the first and the second door levers 60 and 70 are elastically biased by each other.

The second door lever 70 is mounted on the main chassis 100, being stepped with respect to the first door lever 60, to rotate with respect to a second door lever rotary shaft 71. The second door lever 70 includes a second door projection 72, the cam projection 73, a stopper 75, and a guide groove sill 74.

The second door projection 72 is provided on the second lever 70 to guide insertion of the discs 1 and 2 in contact with the discs 1 and 2. The cam projection 73 received in the cam slot of the first door lever 60 moves along the cam slot 63 when the first and the second door levers 60 and 70 are biased by the discs 1 and 2 being inserted, thereby rotating in the ‘D’ and ‘C’ directions, respectively.

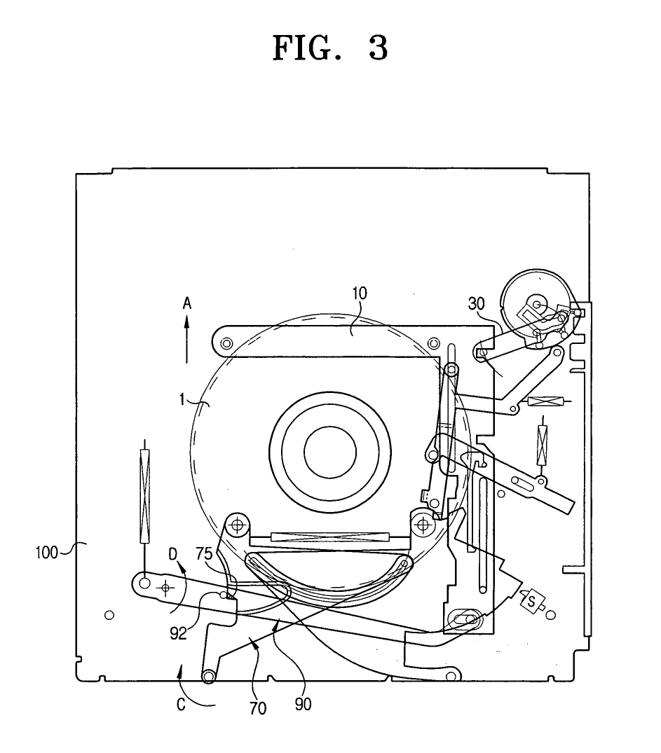

The stopper 75 is protruded on a bottom surface of the second door lever 70, as shown in FIG. 1, toward the main chassis 100. When the first disc 1 operates in the disc drive, the stopper 75 is contacted with an insertion prevention projection 92 of the duplicate insertion prevention lever 90, which will be described hereinbelow, as shown in FIG. 3. If the first disc 1 is already inserted in the disc drive, the stopper 75 obstructs the insertion prevention projection 92. Therefore, the second door lever 70 cannot rotate, and accordingly, another disc is not allowed to be inserted to the disc drive.

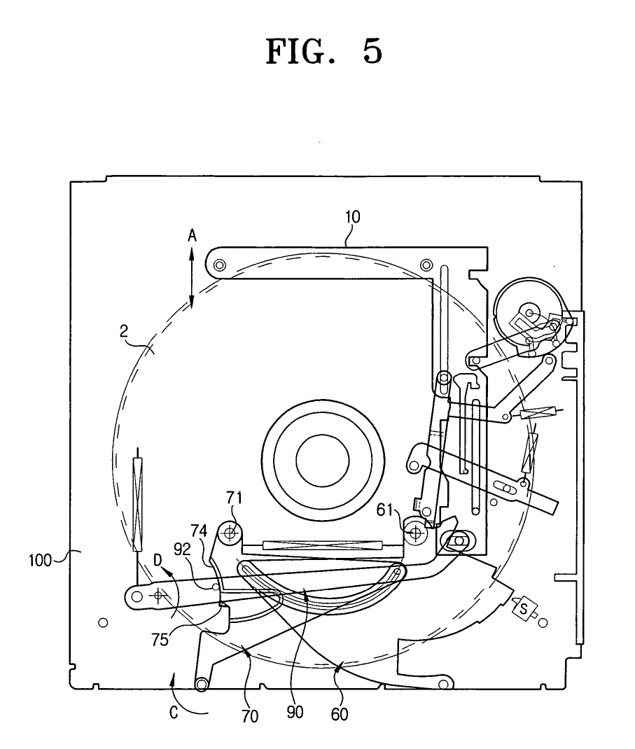

The guide groove sill 74 is formed in an arc shape at one side of the second door lever 70. When the second disc 2 operates in the disc drive, the guide groove sill 74 is contacted with the insertion prevention projection 92 of the duplicate insertion prevention lever 90, as shown in FIG. 5. When the second disc 2 has already been inserted in the disc drive, the guide groove sill 74 obstructs the insertion prevention projection 92. Therefore, the second door lever 70 cannot rotate, and accordingly, the another disc is not allowed to be inserted to the disc drive.

When the disc 1 or 2 is rotated on a turn table, the duplicate insertion prevention lever 90 restrains, in association with the second door lever 70, other discs from being inserted to the disc drive. The duplicate insertion prevention lever 90 is mounted on the main chassis 100 to rotate with respect to a duplicate insertion prevention lever rotary shaft 91 by a predetermined angle and includes the insertion prevention projection 92, a cam boss 93, and an elastic member 94.

The cam boss 93 is received in a cam hole 12 of the disc guide lever 10. Therefore, as the disc guide lever 10 is lifted by the discs 1 and 2, the duplicate insertion prevention lever 90 rotates in the ‘D’ direction with respect to a duplicate insertion prevention lever rotary shaft 91.

The insertion prevention projection 92 is provided on the duplicate insertion prevention lever 90. When the disc 1 or 2 is inserted in the disc drive, the insertion prevention projection 92 is obstructed by the stopper 75 or the guide groove sill 74 so that the second door lever 70 cannot rotate. When inserting the disc 1 or 2 in the disc drive, the duplicate insertion prevention lever 90 is initially positioned as shown in FIG. 1. Therefore, the insertion prevention projection 92 is placed under the second door lever 70, and rotation of the second door lever 70 is not obstructed by the insertion prevention projection 92. Therefore, the disc 1 or 2 may be inserted into the disc drive. When the first disc 1 is inserted and placed on a chucking position, the duplicate insertion prevention lever 90 is contacted with the stopper 75 of the second door lever 70, as shown in FIG. 3. As a result, the second door lever 70 is not able to rotate in the ‘C’ direction. When the second disc 2 is inserted and placed on the chucking position, the duplicate insertion prevention lever 90 is contacted with the guide groove sill 74 of the second door lever 70, as shown in FIG. 5. Accordingly, the second door lever 70 is not able to rotate in the ‘C’ direction.

The elastic member 94 is mounted at one side of the duplicate insertion prevention lever 90 to elastically bias the duplicate insertion prevention lever 90 in the ‘A’ direction.

In FIG. 1, the disc guide lever 10 includes disc guide projections 18 and 19. By contact of the discs 1 and 2 with the guide projections 18 and 19, the disc guide lever 10 is pushed by the discs 1 and 2 and moved in the ‘A’ direction, thereby guiding the discs 1 and 2 to the chucking position.

The pushing lever 50 is mounted on the main chassis 100 to rotate with respect to a pushing lever rotary shaft 51. The pushing lever 50 pushes a slider 80 in the ‘B’ direction in association with the disc guide lever 10, connecting the slider 80 to a power transmission unit (not shown) which drives the transfer roller (not shown).

A gear cam 20 is mounted on the main chassis 100 to rotate with respect to a gear cam rotary shaft 21. In association with a reciprocal movement of the slider 80, the gear cam 20 is rotated by a predetermined angle. The locking lever 40 mounted on the main chassis 100 to rotate with respect to a locking lever rotary shaft 41 controls the disc guide lever 10 to be placed on the chucking position. In association with rotation of the gear cam 20, the locking lever 40 is rotated by a predetermined angle with respect to a locking lever rotary shaft 41 so as to release the disc guide lever 10 which is locked on the chucking position.

A releasing lever 30 is rotatably mounted on the main chassis 100 to rotate with respect to a releasing lever rotary shaft 31. In association with the rotation of the gear cam 20, the releasing lever 30 is rotated by a predetermined angle with respect to a releasing lever rotary shaft 31 so as to separate the disc guide lever from the discs 1 and 2. Therefore, only after the disc guide lever 10 is separated from the discs 1 and 2, the discs 1 and 2 are able to rotate on the turn table (not shown). During the rotation of the discs 1 and 2, an optical pickup (not shown) moves in a radial direction of the discs 1 and 2 to record or reproduce information with respect to the discs 1 and 2.

Hereinbelow, an operation of the duplicate insertion prevention apparatus 210 of the disc drive, according to an embodiment of the present invention, will be described.

When the first disc 1, which is a 80 mm disc, is inserted, the duplicate insertion prevention apparatus 210 operates as follows.

FIG. 1 illustrates the duplicate insertion prevention lever 90 disposed in an initial position. As shown in FIG. 1, the first disc 1 is inserted into the disc drive in the ‘A1’ direction into the disc drive. The disc guide lever 10 is in an initial state where it is not obstructed by the first disc 1. The inserted first disc 1 pushes the first and the second door levers 60 and 70 in contact with the first and the second door projections 62 and 72. The first and the second door levers 60 and 70 rotate with respect to the first and the second door lever rotary shafts 61 and 71 in the ‘D’ and ‘C’ directions, respectively, thereby being distanced from each other. A protruded cam 65 of the first door lever 60 is contacted with the starting switch S, thereby operating the driving motor (not shown). Accordingly, the transfer roller (not shown) rotates, and the first disc 1 is drawn into the disc drive by the transfer roller.

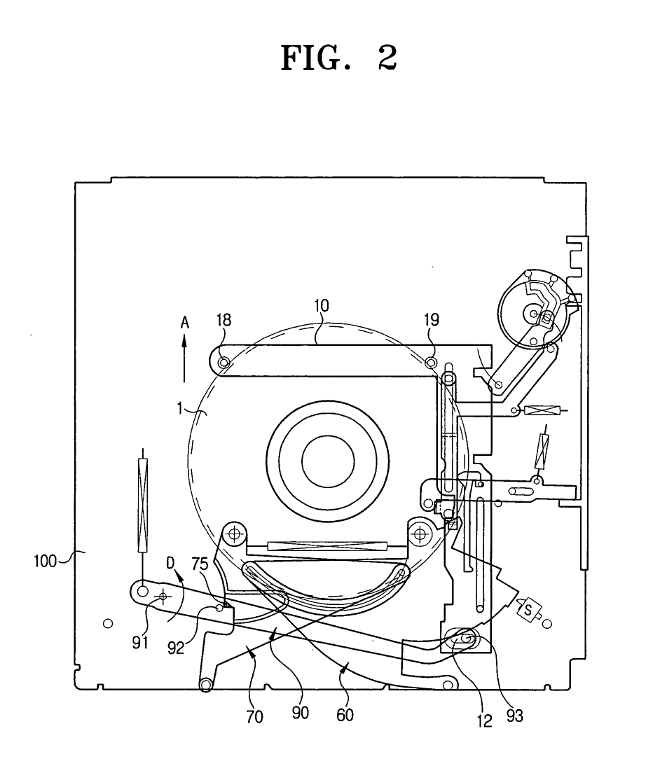

FIG. 2 illustrates the duplicate insertion prevention lever 90 disposed in an intermediate position in a state that the first disc 1 is moved to the chucking position. The first disc 1 being inserted is brought into contact with the disc guide projections 18 and 19 of the disc guide lever 10. By continuous rotation of the transfer roller (not shown), the first disc 1 keeps moving the disc guide lever 10 in the ‘A’ direction, and the disc guide lever 10 stops when it is lifted up to the chucking position. By the disc guide lever 10 being lifted in the ‘A’ direction, the cam boss 93 received in the cam hole 12 of the disc guide lever 10 moves up, and accordingly, the duplicate insertion prevention lever 90 is rotated with respect to the duplicate insertion prevention apparatus rotary shaft 91 by a predetermined angle in the ‘D’ direction. Consequently, the insertion prevention projection 92 of the duplicate insertion prevention lever 90 comes close to the stopper 75 of the second door lever 70.

FIG. 3 illustrates the duplicate insertion prevention lever 90 disposed in a final position where the first disc 1 is rotatable on the turn table after the disc guide lever 10 is separated from the first disc 1 disposed on the chucking position. As shown in FIG. 3, the disc guide lever 10 is separated by a certain distance from the chucking position (FIG. 2) in the ‘A’ direction by the releasing lever 30. Accordingly, the duplicate insertion prevention lever 90 is more rotated from the chucking position in the ‘D’ direction, contacting with one side of the stopper 75 of the second door lever 70 by the insertion prevention projection 92 thereof.

If the second door lever 70 is rotated in ‘C’ direction, in this state, by insertion of another disc, the insertion prevention projection 92 of the duplicate insertion prevention lever 90 obstructs the stopper 75 of the second door lever 70, restraining the second door lever 70 from rotating. As a result, the another disc can not enter the disc drive.

When the second disc 2, which is a 120 mm disc, is inserted, the duplicate insertion prevention apparatus 210 operates as described below.

As shown in FIG. 1 in which the duplicate insertion prevention lever 90 is in the initial position, the second disc 2 is inserted in the disc drive in the ‘A1’ direction, that is, a loading direction. The inserted second disc 2 pushes the first and the second door levers 60 and 70, in contact with the first and the second door projections 62 and 72 of the first and the second door levers 60 and 70. The first and the second door levers 60 and 70 are rotated in the ‘D’ and ‘C’ direction with respect to the first and the second door lever rotary shaft 61 and 71, respectively, thereby being distanced from each other. The protruded cam 65 of the first door lever 60 is contacted with the start switch S, operating the driving motor (not shown). Accordingly, the transfer roller (not shown) rotates, and the second disc 2 is drawn into the disc drive by the transfer roller.

When inserting the second disc 2 having a greater diameter than the first disc 1, the first door lever 60 is rotated in the ‘D’ direction with respect to the first door lever rotary shaft 61 by a greater degree compared to when inserting the first disc 1. The position controlling projection 44 of the locking lever 40 which is in association with the pushing projection 64 of the first door lever 60 biases the stopper projection 52 of a pushing lever 50 in the ‘E’ direction. Accordingly, the pushing lever 50 is moved in the ‘E’ direction. Therefore, when inserting the second disc 2, the disc guide lever 10 may be lifted in the ‘A’ direction more than when inserting the first disc 1, without interference by the stopper boss 53.

FIG. 4 illustrates the duplicate insertion prevention lever 90 disposed in an intermediate position in which the second disc 2 is moved to the chucking position. The second disc 2 being inserted is brought into contact with the disc guide projections 18 and 19 of the disc guide lever 10. By continuous rotation of the transfer roller, the first disc 1 keeps moving the disc guide lever 10 in the ‘A’ direction, and the disc guide lever 10 stops when lifted up to the chucking position.

Since the second door lever 70 is rotated in the ‘C’ direction with respect to the second door lever rotary shaft 71 by a greater degree compared to when inserting the first disc 1, the insertion prevention projection 92 of the duplicate insertion prevention lever 90 is lifted toward the guide groove sill 74 of the second door lever 70 through a path ‘G’. While the second door lever 70 is rotated by insertion of the second disc 2, the duplicate insertion prevention lever 90 is rotated by a predetermined angle in the ‘D’ direction due to the disc guide lever 10 being lifted. Therefore the insertion prevention projection 92 disposed in front of the stopper 75 is lifted in the ‘A’ direction. Accordingly, when the second door lever 70 is returned to an initial state after insertion of the second disc 2, the insertion prevention projection 92 is disposed behind the stopper 75.

FIG. 5 shows the duplicate insertion prevention lever 90 disposed in a final position where the second disc 2 is rotatable on the turn table after the disc guide lever 10 is separated from the second disc 2 disposed on the chucking position. As shown in FIG. 5, the disc guide lever 10 is separated by a certain distance from the chucking position (FIG. 4) in the ‘A’ direction by the releasing lever 30. Accordingly, the duplicate insertion prevention lever 90 is more rotated from the chucking position in the ‘D’ direction, contacting with the guide groove sill 74 of the second door lever 70 by the insertion prevention projection 92 thereof.

If the second door lever 70 is rotated in the ‘C’ direction, in this state, by insertion of another disc, the insertion prevention projection 92 of the duplicate insertion prevention lever 90 obstructs the guide groove sill 74 of the second door lever 70, restraining the second door lever 70 from rotating. As a result, the other disc can not enter the disc drive.

According to the above description of the duplicate insertion prevention apparatus 210, when a disc is already inserted in the disc drive, insertion of another disc may be prevented by using a simple structure including the door levers 60 and 70 and the duplicate insertion prevention lever 90.

Furthermore, since the duplicate insertion prevention apparatus 210 does not require an additional space for installment, the disc drive may be manufactured with a shin configuration, thereby saving the manufacturing cost.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A duplicate insertion prevention apparatus for a disc drive, comprising:
at least one door lever to guide a disc being inserted to the disc drive, in contact with the disc; and
a duplicate insertion prevention lever to restrain the door lever from rotating when the disc is in operation in the disc drive, preventing insertion of another disc.

2. The duplicate insertion prevention apparatus of claim 1, wherein the door lever comprises a first door lever and a second door lever.

3. The duplicate insertion prevention apparatus of claim 2, wherein the first and the second door levers respectively include first and second door projections contacted with the disc to guide the disc.

4. The duplicate insertion prevention apparatus of claim 3, wherein the duplicate insertion prevention lever moves among an initial position where the disc is being inserted, an intermediate position where the disc is placed in a chucking position, and a final position where the disc is rotating on a turn table.

5. The duplicate insertion prevention apparatus of claim 4, wherein the intermediate position and the final position are determined to be different according to a size of the disc being inserted.

6. The duplicate insertion prevention apparatus of claim 5, wherein the duplicate insertion prevention lever includes an insertion prevention projection to obstruct the second door lever, restraining rotation of the second door lever when another disc is additionally inserted.

7. The duplicate insertion prevention apparatus of claim 6, wherein the second door lever comprises a stopper and a guide groove sill being selectively contacted with the insertion prevention projection according to a size of the disc.

8. The duplicate insertion prevention apparatus of claim 7, wherein the first door lever comprises a protruded cam being contacted with a start switch that operates a driving motor, and a cam slot to guide a movement of the second door lever.

9. The duplicate insertion prevention apparatus of claim 8, wherein the second door lever comprises a cam projection to be inserted into the cam slot.

10. The duplicate insertion prevention apparatus of claim 3, further comprising:
an elastic member to connect the first and the second door levers.

11. A duplicate insertion prevention apparatus for a disc drive, comprising;
a first door lever and second door lever to guide a disc being inserted to the disc drive, in contact with the disc; and
a duplication insertion prevention lever to restrain the second door lever from rotating when the disc is in operation in the disc drive, preventing insertion of another disc.

12. The duplicate insertion prevention apparatus of claim 11, wherein the duplicate insertion prevention lever moves among an initial position where the disc is being inserted, an intermediate position where the disc is placed in a chucking position, and a final position where the disc is rotating on a turn table.

13. The duplicate insertion prevention apparatus of claim 12, wherein the intermediate position and the final position are determined to be different according to a size of the disc being inserted.

14. The duplicate insertion prevention apparatus of claim 11, wherein the first door lever is mounted on a main chassis to rotate with respect to a first door lever rotary shaft, and the second door lever is mounted on the main chassis, being stepped with respect to the first door lever, to rotate with respect to a second door lever rotary shaft.

15. The duplicate insertion prevention apparatus of claim 11, wherein the duplicate insertion prevention lever is mounted on the main chassis to rotate with respect to a duplicate insertion prevention lever rotary shaft by a predetermined angle.

16. A duplicate insertion prevention apparatus for a disc loading device, comprising;
a first door lever and second door lever to guide a disc being inserted to the disc loading device in contact with the disc; and
a duplicate insertion prevention lever disposed on a front of a main chassis of the disc loading device to guide insertion of the disc and prevent insertion of another disc when the other disc is inserted in the disc loading device.

17. The duplicate insertion prevention apparatus of claim 16, wherein the duplication insertion prevention lever restrains the second door lever from rotating when the disc is in operation in the disc loading device, preventing insertion of the another disc.

18. The duplicate insertion prevention apparatus of claim 17, wherein the duplication insertion prevention lever includes an insertion prevention projection to obstruct the second door lever, restraining rotation of the second door lever when the another disc is additionally inserted.
